(19) United States
(12) Patent Application Publication
(10) Pub. No.: US 2012/0264503 A1
(43) Pub. Date: Oct. 18, 2012

(54) FANTASY SPORTS WAGERING

(76) Inventor: James J. Lisenbee, Acampo, CA (US)

(21) Appl. No.: 13/444,776

(22) Filed: Apr. 11, 2012

Related U.S. Application Data
(60) Provisional application No. 61/474,672, filed on Apr. 12, 2011.

(51) Int. Cl. A63F 13/12

(52) U.S. Cl. 463/25; 463/42

(57) ABSTRACT

Systems, methods, and other embodiments for bringing about fantasy sports wagering are described.

### CROSS REFERENCE TO RELATED APPLICATIONS

This application claims priority under 35 U.S.C.§119(e) from U.S. provisional patent application No. 61/474,672, filed Apr. 12, 2011, the entire contents of which are incorporated herein by reference.

### BACKGROUND

As a result of the legalization of various types of betting and sports gambling in the United States, brick and mortar casinos, as well as online gambling establishments, now provide a significant source of entertainment and amusement for sports fans. This allows sports fans and other enthusiasts to enjoy sports in a manner that may also provide jobs for casino workers, tax revenues for state and local governments, and thus increase the quality of life for society as a whole.

To bring about conventional sports betting, a “sports book” may be created to offer wagering odds to bettors. Generally, when betting on a sports competition, the team that is likely to win the competition is assigned lower odds, while the team less likely to win the competition is assigned higher odds. Additionally, in many instances, a point spread may be used to as a handicap to the team more likely to win the competition, a betting line may be established for over/under wagers, and “parlay” plays may be used for increased payouts. The use of these wagering options provides an additional dimension of amusement above and beyond merely betting on whether a particular team will win or lose a competition.

However, sports fans may lament the fact that only a limited number of sporting events are available during a particular sporting season. For example, the American football season extends for only a 16 games, which, for may be far too few sporting events for many diehard sports fans. Many sports fans would appreciate a greater number of events that may involve one or more of their favorite players of the particular sport.

### SUMMARY

In an embodiment, a method includes receiving assignments of a plurality of players to a first fantasy team, receiving, by way of a computer, a plurality of wagers placed at first and second sides of the betting line, wherein the betting line represents an estimated outcome of the fantasy scoring event, the fantasy scoring event being based, at least in part, on one or more competitive events between real-world teams that include the plurality of players. The method may also include receiving adjustments, by way of a computer, to the betting line resulting, at least in part, from detecting an imbalance between wagers among the plurality of wagers placed at a first side of the betting line and wagers among the plurality of wagers placed a second side of the betting line.

In another embodiment, a system includes a receiver module for receiving one or more real-world performance metrics of players of a first fantasy team, a scoring module for computing an outcome of a fantasy scoring event based, at least in part, on competitive events between real-world teams that include the players of the first fantasy team, and a certification module for certifying that players of the first fantasy team are available for participation in the fantasy scoring event.

In another embodiment, an interface for a fantasy sports wagering system includes an input module for receiving performance indications for a plurality of players, wherein the performance indications correspond to real-world performance metrics of the plurality of players. The interface further includes a certifying module, coupled to the input module, for certifying that the plurality of players is available for a fantasy competition. The interface further includes an output module for awarding compensation based, at least in part, on an outcome of the fantasy scoring event and an output of the certifying module.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one example of the boundaries. In some examples, one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one embodiment of system for fantasy sports wagering system.

FIG. 2 illustrates an embodiment of a method associated with fantasy sports wagering during preplay and play phases of fantasy sports competitions.

FIG. 3 illustrates an embodiment of a method associated with fantasy sports wagering during post-play phases of fantasy sports competitions.

FIG. 4 illustrates an embodiment of a method associated with fantasy sports wagering prior to seasonal real-world sports competitions.

### DETAILED DESCRIPTION

Described herein are example systems, methods, and other embodiments associated with fantasy sports wagering. Embodiments of the invention provide sports fans and other enthusiasts with resources that enable the creation of a sports book for fantasy teams and to name each fantasy team according to various naming conventions, such as after the real-world team's quarterback in the case of a fantasy football team. Each player's real-world performance metrics, such as, for example, a quarterback's pass-completion percentage, average passing yardage, and so forth, may be evaluated and combined to form a single performance indicator that may be used during a fantasy sports competition. In at least one embodiment, in the event that a real-world player, for reasons such as injury, cancellation of a real-world sporting event due to weather, and so forth, has not been available to participate in a real-world sports competition, over a particular time span, the nonparticipating player may not be available for placement on a fantasy sports team.

In some embodiments, fantasy teams for a particular fantasy sports competition may be selected, at least in part, on an outcome of a checking or verifying function that certifies that all players on a fantasy team roster have played during a previous time span, such as the previous week, two weeks, three weeks, and so forth. In the event that one or more players have not played in a corresponding real-world event during the time span, the player may be excluded from selection on a roster of the fantasy team.

After building fantasy sports teams, a system for fantasy sports wagering may accept wagers from users on first and second sides of a betting line for a scoring event. In response to detecting an imbalance between wagers placed to a first side of the betting line versus wagers placed to a second side of the betting line, the system may, without user input, adjust the betting line to at least approximately equalize the number of wagers, or the monetary amount, present at each of the two sides of the betting line. In another embodiment, the system may, in response to a user input, adjust the betting line to equalize the number of wagers or the monetary amount present at each of the two sides of the betting line. In other embodiments, the system may accept wagers for a point spread, between two fantasy scoring events

In the example fantasy roster in Table 1 below, which identifies a fantasy version of the American football team the New Orleans Saints, a real-world quarterback (Drew Brees) has been ranked first in the quarterback (QB) position. According to indicators of one or more scoring structures, which may take into account real-world player performance metrics of a quarterback, such as passing yardage, rushing yardage, number of interceptions per game, fumbles, sacks, and so forth, an average score per game is shown as being equal to 564, for example. In Table 1, the fantasy roster has been given the New Orleans Saints name according to the quarterback (i.e. Drew Brees) included on the real-world team.

TABLE 1
Fantasy Roster: New Orleans Saints

| | | | Real-World | |
|---|---|---|---|---|
| Rank | Name | Position | Team | Average Score |
| 1 | Drew Brees | QB | Saints | 564 |
| 2 | Marshawn | RB | Seahawks | 316 |
| | Lynch | | | |
| 3 | Ryan | RB | Chargers | 307 |
| | Matthews | | | |
| 1 | Demaryius | WR | Broncos | 306 |
| | Thomas | | | |
| 2 | Roddy White | WR | Falcons | 285 |
| 1 | Rob | TE | Patriots | 268 |
| | Gronkowski | | | |

Defense

| Real-World Team | Average Score |
|---|---|
| Seattle Seahawks | −43 |

Line

| | | | |
|---|---|---|---|
| Rank | Average Score | Line | Options |

| | | | | |
|---|---|---|---|---|
| 1 | 2003 | 1739 | [symbol] [symbol] | Next |

The example fantasy roster of Table 1, additional players, such as running backs (RBs), wide receivers (WRs), and a tight end (TE) are shown along with player performance indicators based on real-world player performance metrics. Thus, for example, the real-world player Demaryius Lynch, is shown in the example fantasy roster of Table 1 as being first ranked as a wide receiver. In an example, such a ranking may be assigned according to the wide receiver's average number of completed passes per game, average yardage per completed pass, completions resulting in a touchdown, and so forth. Although other players are shown in Table 1 as being perhaps ranked second, or third, nothing prevents the receiving of assignments of all first ranked players to a particular six-member fantasy sports team. In the instance of Table 1, the first ranked running back, for example, may be listed as “injured” on a real-world New Orleans Saints football team. Thus, at least in one implementation, the injured player would not be available for participation on a fantasy sports team.

The example fantasy roster of Table 1 includes real-world performance metrics related to an opposing team's defense. In the example of Table 1, an example defense for the real-world Seattle Seahawks football team has been received an assigned average score of −43. In an embodiment, the average score represents a performance indicator based on real-world performance metrics of the team. In a possible example, average score may be determined by aggregating or something player performance metrics such as yards allowed per running play of an opposing offense, yards allowed per passing play of an opposing offense, the total number of yards allowed in a game, and so forth.

The example fantasy roster of Table 1 additionally includes a composite ranking of a team, such as the New Orleans Saints football team, which, in this example, has been ranked first. Table 1 further includes an average score, which may be based on a summation of each player's average score minus an average score for the defense of a given opponent. For the example of Table 1, the average score of 2003 has been computed by summing the average scores of the players comprising the fantasy roster minus the average score presented by an opponent's defense. In computing the betting line, which, for the example of Table 1, is 1739. In embodiments, this number has been calculated using any one of many algorithms. In other embodiments, the betting line may also be arrived at by way of empirical data. In the “options” column, an above/below button is shown to symbolize the user's ability to place a wager as to whether the outcome of a fantasy scoring event will actually compute to an amount betting line.

In Table 2, below, a set of fantasy football game lines that includes 20 fantasy football teams is shown. In Table 2, a set of 20 teams may be drawn from a larger set of 32 teams of a real-world league. However, in other embodiments, a smaller set of teams, such as 10, 12, 16 teams, or a larger set of teams, such as 22, 24, or 28 teams may be identified. In accordance with Table 1, the name of each fantasy team of Table 2 corresponds to the real-world team that includes the quarterback of the fantasy team. Thus, for example, the real-world New Orleans Saints and the fantasy New Orleans Saints both feature Drew Brees as quarterback.

TABLE 2

| Rank | Name | Average Score | Line | Options |
|---|---|---|---|---|
| 1 | Saints | 2003 | 1739 | [symbol] [symbol] |
| 2 | Patriots | 1765 | 1433 | [symbol] [symbol] |
| 3 | Packers | 1618 | 1427 | [symbol] [symbol] |
| 4 | Panthers | 1476 | 1490 | [symbol] [symbol] |
| 5 | Falcons | 1355 | 1412 | [symbol] [symbol] |
| 6 | Lions | 1304 | 1148 | [symbol] [symbol] |
| . . . | . . . | . . . | . . . | . . . |
| 20 | Seahawks | 603 | 671 | [symbol] [symbol] |

In the example of Table 2, an average score may be shown for each team in which the score corresponds to an aggregate or a summation of the individual performance indicators for each player minus a performance indicator for a given opponent in a fantasy scoring event. Consistent with Table 1, the user may be given an option to place a wager on the scoring event as to whether an outcome of the fantasy scoring event will be over (e.g. above) or under (e.g. under) a betting line. In an embodiment, a user may place a wager on a point spread that may be dependent on an outcome of two scoring events, such as a scoring event involving the New Orleans Saints fantasy football team and the New England Patriots fantasy football team. In such an embodiment, a user may place a wager as to whether the point spread resulting from scoring events involving the Saints and the Patriots would be above or below the difference between 1739 and 1433 (306) points.

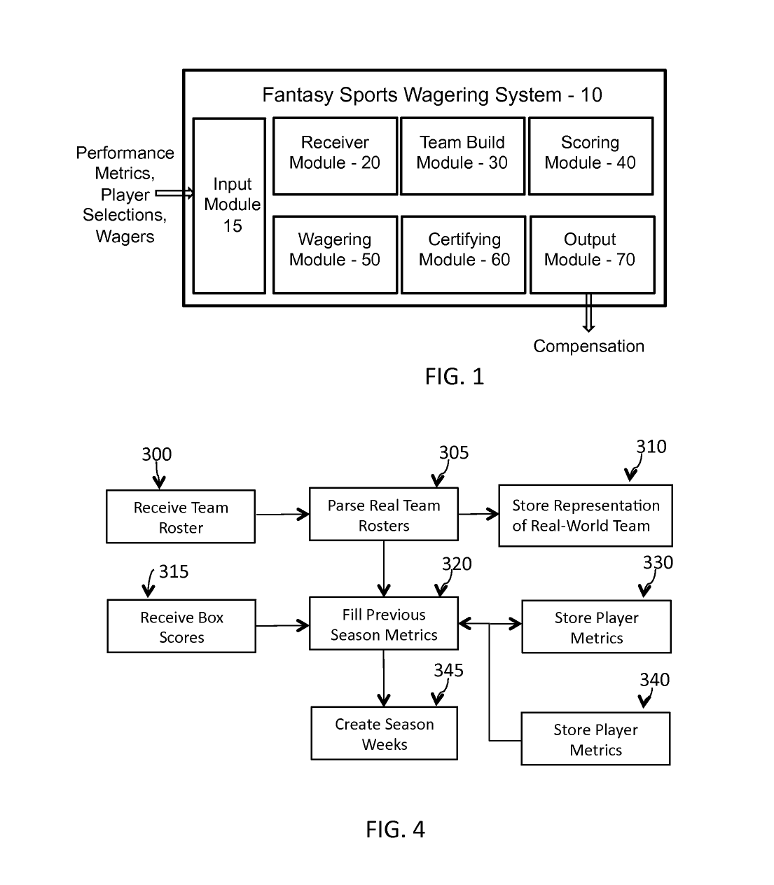

With reference to FIG. 1, one embodiment of computerized system for a fantasy sports wagering system is shown. In FIG. 1, real-world performance metrics, such as individual player performance statistics, are provided by way of a “feed” through input module 15 to receiver module 20 of fantasy sports wagering system 10. Performance metrics may include, for example, in the case of a quarterback, a percentage of completed passes, an average number of yards per completion, likelihood of being “sacked” by defenders, and so forth. In a possible example, performance metrics may include, for example, in the case of a fantasy baseball team, a pitcher's earned run average, percentage of batters that strikeout when facing the picture, and so forth. Further, various aspects of real-world performance metrics may be dependent on particular types of opponents. In one example, a quarterback's completion percentage may be expressed in relation to a particular quality of defense, such as a top-ranked, middle-ranked, or lower-ranked defense. It should be understood that performance metrics may include a variety of real-world player metrics, such as may be encountered in football, hockey, basketball, baseball, or in any other athletic activity.

In the example of FIG. 1, wagers placed by various users may also be conveyed by way of input module 15 to receiver module 20. In one embodiment, wagers may be associated with a particular outcome of the fantasy scoring event. In one example, a bettor may place a wager that a particular team will prevail over an opponent in a fantasy scoring event. In another example, a bettor may place a wager that two scoring events involving fantasy teams will result in a certain point spread separating the outcome the scoring events. In another example, a bettor may place a wager that a particular fantasy team will score over or under (e.g. above or below) a betting line. In another example, a bettor may place a wager on the outcome of two or more outcomes for increased awards.

Performance metrics of real-world players and teams may be conveyed to team build module 30. In embodiments, team build module 30 assembles a fantasy sports team using those real-world players having particular favorable performance metrics. In one example, such as in the case of a fantasy football team, team build module 30 may assemble a fantasy team that includes six members, comprising, for example, a top-ranked quarterback, a top-ranked running back, one or more top-ranked receivers, and so forth. In an example, team build module 30 may assign a single performance indicator that reflects an aggregate of performance metrics. Accordingly, for such an example, a quarterback may be top-ranked against particular types of defenses. Thus, a quarterback may be top-ranked against a defense having a weak secondary, but may be middle-ranked against a defense having strong linebackers. In a baseball example, a batter may be top-ranked when batting average against left-handed pitchers but may be only middle-ranked against right-handed pitchers. Accordingly, performance metrics may be updated on occasion according to the attributes of a particular opponent in a fantasy scoring event. In one embodiment, at the completion of the building process, team build module 30 may name the assembled team, perhaps to agree with the quarterback or other dominant player of the assembled fantasy sports team.

In another embodiment, input module 15 of fantasy sports wagering system 10 may also receive player selections, which, for example, may enable a user to build their own fantasy sports team. Thus, for example, a user may mix and match a team using players of various rankings to construct a fantasy team.

FIG. 1 also includes scoring module 40, which may compute an expected outcome of scoring event of a fantasy sports teams. In embodiments, scoring module 40 makes use of one or more scoring algorithms or scoring structures. In one example, for the case of a fantasy football team, a quarterback may receive an assignment for a point score (i.e. six points) for a touchdown achieved by way of a completed pass, but may lose two points for an intercepted pass or a fumble. In another scoring structure, a quarterback may be assigned seven points for a touchdown achieved by way of a completed pass, but may lose three points for an intercepted pass or a fumble. Through the use of such algorithms or scoring structures, scoring module 40 performs the computational scoring activities that allow the fantasy sports event to be “played.”

At the close of the fantasy scoring competition, output module 70 may provide output signals representing monetary or nonmonetary compensation for those bettors that predicted or at least favorably estimated the outcome of the fantasy scoring event. Thus, compensation may be paid in the form of data signals representing a dollar amount to be conveyed to a user's account or may be paid in the form of promotional credits conveyed to a user's account. In an embodiment, promotional credits may be in the form of tokens or chips redeemable at one or more virtual or actual (brick-and-mortar) casinos. In another embodiment, promotional credits may be awarded for the amount of time playing one or more games.

Prior to the initiation of the fantasy scoring event, wagering module 50 may be used to manage one or more betting lines associated with the event. In one example, a betting line may be established between possible outcomes of the fantasy scoring event. Wagering module 50 may also establish a point spread, win/lose odds, betting line, and so forth. Further, wagering module 50 may also manage a betting line as wagers are received by receiver module 20. For example, in the event that users are placing wagers disproportionately to one side of the betting line, wagering module 50 may adjust the betting line in a manner that promotes the correction of the imbalance. By way of adjusting to the betting line, wagering module 50 may approximately equalize the number of wagers placed at the sides of the betting line, may approximately equalize the monetary value of wagers placed at the sides of the betting line, or may approximately equalize promotional credits or other nonmonetary compensation payable or redeemable according wagers placed at the sides of the betting line.

Also prior to the initiation of the fantasy scoring event, certifying module 60 may perform a checking function to ensure that all selected players for each fantasy sports team have played in real-world competitive events during a particular time span prior to the fantasy scoring event. In one example, certifying module 60 may validate that all players selected by team build module 30, or perhaps selected by way of a user interfacing with input module 15, have played in real-world events during a time span approximately equal to the previous week, two weeks, three weeks, or other period. In an example, a player for the fantasy scoring event may have been precluded from real-world play due to an injury, weather cancellation of a real-world competitive event, or other event. Further, nothing prevents a first time span, such as two weeks, being employed by team build module 30 in assembling a first fantasy sports team, while a second, different, time span, such as three weeks, is employed by team build module 30 in assembling a second fantasy sports team.

Certifying module 60 may operate through the use of a status indication signal representing information states representing player availability from receiver module 20. In an embodiment, a status indicator may assume a first state if a particular player has participated in a real-world sports event over a particular time span prior to the fantasy scoring event. The status indicator may assume a second state if a particular player has not participated in a real-world sports event during that particular time span. Thus, as a result of the state of the status indication signal from receiver module 20, certifying module 60 may cancel one or more wagers.

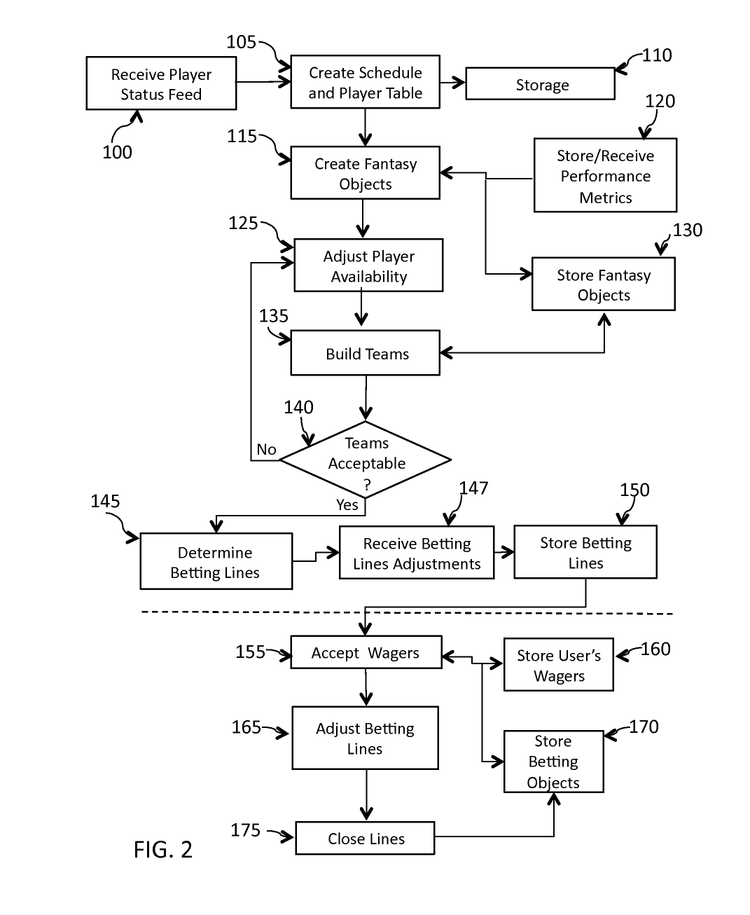

FIG. 2 illustrates an embodiment of a method associated with fantasy sports wagering during preplay and play phases of fantasy sports competitions. In some embodiments, the system of FIG. 1 may be suitable for performing the methods of FIGS. 2, 3, and 4, although nothing prevents performing the method of Figure FIGS. 2, 3, and 4 using alternate arrangements of components in other embodiments. Embodiments may include blocks in addition to those shown and described in FIGS. 2, 3, and 4, fewer blocks than those shown and described in FIGS. 2, 3, and 4, blocks occurring in a different order than those shown and described in FIGS. 2, 3, and 4, or any combination thereof.

At block 100, a player status is received from an external source. Block 100 may include receiving signals by way of an RSS feed or other mechanism for delivering regularly or occasionally changing content. In the context of FIG. 2, block 100 may include receiving signals representing weather cancellation of real-world sports competitions, injury reports of one or more players, player strikes, an absence of player-scoring information, roster updates, or other event. At block 105, signals received at block 100 may be used to infer real-world competitive events. For example, the presence of a large weather disturbance may result in an inference that real-world competitive events have not taken place in a certain region affected by the disturbance or affect the predicted outcomes of the players. Block 105 may also include the receipt of player injury information, and may also include a system administrator or curator manually entering real-world competitive event information related to weather disturbances, player injuries, and other potentially disruptive events. At block 110, player injury information, manually entered real-world information, and other information states may be stored for future reference.

At block 115, fantasy versions of players, may be created and scored using one or more scoring structures, based, at least in part, on performance metrics received at block 120. In an implementation, block 120 may represent the calculation or estimation of performance metrics based on stored data. As mentioned previously, these metrics may include, for example, a football quarterback's pass completion percentage against a particular type of defense, a baseball player's batting average, or other metrics. Players may be identified as being ranked relative to other players within the same positions, such as a top-ranked wide receiver as measured against a group of real-world wide receivers for use in a fantasy football competition, for example. At block 115, fantasy teams may be created, and named, perhaps according to a dominant player of fantasy sports team. At block 130, fantasy objects created at 115 may be stored.

In an embodiment, fantasy teams created at block 115 remain empty until block 125, at which player availability may be adjusted. Block 125 may entail validating that players proposed for fantasy teams have played during particular time span prior to the fantasy scoring events, such as one week, two weeks, three weeks, and so forth. The method may proceed to block 135, in which players validated for participation on a fantasy team are aggregated to build one or more fantasy teams. Objects representing fantasy teams may be stored, as in block 130.

At block 140, a determination is made, perhaps by an administrator, as to whether fantasy team assignments meet any applicable criteria. This may include a reasonableness test to determine that all performance indications for players assigned to fantasy teams are within acceptable ranges. If the determination of block 140 results in a performance indicator not being within acceptable ranges, block 125 is performed in which player availability may be adjusted, by modifying a performance indicator of a player, by excluding a player, or by performing other adjustments. If the determination of block 140 indicates that all performance indicators are within acceptable ranges, block 145 may be performed in which betting lines may be determined. At block 147, adjustments to the betting lines may be received and the betting lines may be adjusted before opening and/or after opening. At block 145, performance indicators for fantasy players may be aggregated by way of a computing process and a predicted score may be estimated for the outcome of the fantasy scoring event. Betting lines may then be stored, as in block 150.

At block 155, wagers placed at the sides of betting lines may be accepted. In an embodiment, once a user places a wager, the user may be blocked from making further wagers until the betting line moves in a direction opposite to the wager. Records of user's wagers may then be stored, as in block 160. Individual betting objects may also be stored, as in block 170. At block 165, betting lines may be adjusted perhaps, in response, to an imbalance in the number of wagers, or an imbalance in the aggregated monetary amount of wagers, placed to a side of a betting line. Such adjustment may be used to balance the aggregate of wagers placed to either side of the betting line.

In the embodiment of FIG. 2, betting lines may be closed, such as at block 175. In such an embodiment, a real-world sports competition may, perhaps unfairly, influence the outcome of the fantasy scoring event. Accordingly, to conclude such impact, block 175 may be performed, and final wagers stored, as in block 170.

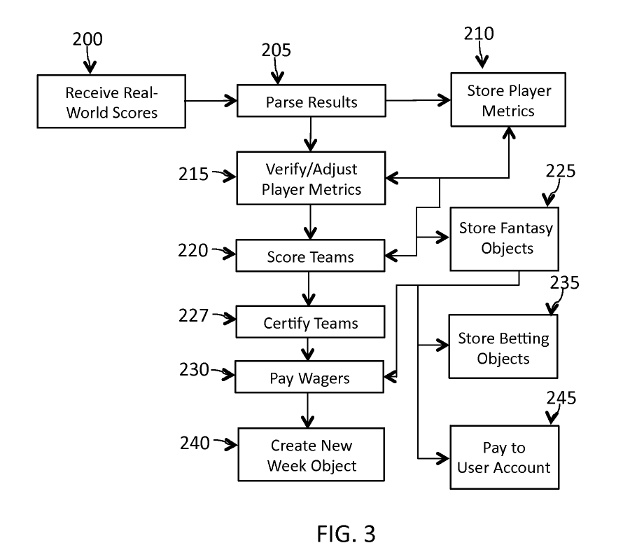

FIG. 3 illustrates an embodiment of a method associated with fantasy sports wagering during post-play phases of fantasy sports scoring events. The method of FIG. 3 begins at block 200, in which real-world box scores, which may include several statistics or other performance metrics for a particular real-world competitive event, are received perhaps by way of a rich site summary (RSS) feed. At block 205, the received box scores may be parsed and associated with one or more real-world players participating in the real-world competitive event. At block 210, performance metrics associated with individual players may be stored.

At block 215, individual player metrics may be adjusted to accommodate, or to exclude metrics that may reflect unreasonable values. In one possible example, a quarterback's completion percentage may be adjusted from 305.0% to 30.5%. Adjusted metrics may then be stored, such as in block 210. The method may continue at block 220, in which teams may be scored using one or more scoring structures applied to the performance indications derived from various real-world performance metrics. For example, a scoring structure may be applied to a team based on an aggregation of individual player performance indications combined with a composite performance indication for performance of a team's defense to arrive at an overall team performance indication. Fantasy objects associated with the team's scoring structure may be stored, as in block 225. At block 227, fantasy teams are certified for player participation, wagers associated with non-certified teams are canceled.

The method may continue at block 230, which may include paying wagers resulting from the team scoring structure of block 220. Betting objects pertaining to the amount of the wager paid may be stored at block 235. Payment may be made to the user accounts, such as at block 245.

FIG. 4 illustrates an embodiment of a method associated with fantasy sports wagering prior to seasonal or real-world sports competitions. The method of FIG. 4 begins at block 300, in which a real-world team roster comprising real-world players may be received. At block 305, the real-world team roster may be parsed to provide an internal representation the real-world team and the individual players comprising each team.

At block 315, a box score for each previously played competition is received. At block 320, box scores for competitive events from a final portion of the previous real-world season may be parsed to provide performance indications for fantasy players. In another embodiment, performance indications from previous fantasy scoring events, such as in block 340, may be used to provide an initial set of performance indications for a subsequent season. Individual player performance indications may then be stored, as in block 330. At block 345, individual objects corresponding to weeks of the real-world season may be created, with week one of the real-world seasons set as the current season week. At block 345, week objects correspond to internal representations of real world season weeks. In embodiments, season weeks may be used to organize and arrange information states associated with real-world and fantasy team scoring events.

With the present systems and methods, wagering on fantasy scoring events may be enabled. Performance metrics reflecting the real-world performance of athletes may be used to provide indications of the particular athlete playing in a fantasy scoring event. A betting line may be established and adjusted to preclude a disproportionate number of wagers placed to one side of the betting line. By coupling fantasy scoring events with real-world sporting competitions, and enabling wagering on the fantasy scoring events, sports fans may further enjoy sports competitions of all types.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

To the extent that the term “includes” or “including” is employed in the detailed description or the claims, it is intended to be inclusive in a manner similar to the term “comprising” as that term is interpreted when employed as a transitional word in a claim.

While example systems, methods, and so forth, have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so forth described herein. Therefore, the disclosure is not limited to the specific details, the representative apparatus, and illustrative examples shown and described. Thus, this application is intended to embrace alterations, modifications, and variations that fall within the scope of the appended claims.

What is claimed is:

1. A method, comprising:
receiving assignments of a plurality of players to a first fantasy team;
receiving, by way of a computer, a plurality of wagers placed at first and second sides of a betting line, the betting line representing an estimated outcome of a fantasy scoring event, the fantasy scoring event being based, at least in part, on one or more competitive events between real-world teams that include the plurality of players; and
receiving adjustments, by way of a computer, to the betting line resulting, at least in part, from detecting an imbalance between wagers among the plurality of wagers placed at a first side of the betting line and wagers among the plurality of wagers placed at a second side of the betting line.

2. The method of claim 1, additionally comprising:
assigning at least one performance indicator to individual players of the plurality of players based, at least in part, on one or more real-world performance metrics from the one or more competitive events occurring during a first time span prior to the fantasy scoring event,
wherein the at least one performance indicator influences an outcome of the fantasy scoring event.

3. The method of claim 1, additionally comprising naming the first fantasy team after a real-world player assigned to the first fantasy team.

4. The method of claim 1, additionally comprising:
canceling at least some of the plurality of wagers based, at least in part, on a status indicator of at least one player assigned to the first fantasy team.

5. The method of claim 4, wherein
the status indicator of the at least one player assigned to the first fantasy team relates to an injury received to a real-world player during a first time span prior to the fantasy scoring event.

6. The method of claim 1, additionally comprising:
certifying at least some of the plurality of wagers based, at least in part, on an absence of a status indicator of at least one player assigned to the first fantasy team.

7. The method of claim 1, additionally comprising:
receiving by way of a computer, a plurality of wagers placed at first and second sides of a point spread, the point spread representing a difference in computed outcome of the fantasy scoring event involving the first fantasy team and a fantasy scoring event involving a second fantasy team, wherein
the adjusting the betting line resulting, at least in part, from detecting an imbalance between wagers among the plurality of wagers additionally comprises modifying the point spread.

8. The method of claim 1 wherein assigning comprises:
receiving an input signal from a user interface that assigns at least one of the plurality of players to the first fantasy team.

9. A system, comprising:
a receiver module for receiving one or more real-world performance metrics of players of a first fantasy team;
a scoring module for computing an outcome of a fantasy scoring event based, at least in part, on competitive events between real-world teams that include the players of the first fantasy team; and
a certification module for certifying that players of the first fantasy team are available for participation in the fantasy scoring event.

10. The system of claim 9, additionally comprising:
a wagering module for receiving a plurality of wagers placed at first and second sides of a betting line.

11. The system of claim 10, wherein
the certification module additionally cancels the plurality of wagers if at least one player of the first fantasy team or at least one player of at least one other fantasy team is not available.

12. The system of claim 10, wherein
the wagering module adjusts the betting line if an imbalance is present between wagers of the plurality of wagers placed on the first side of the betting line and wagers of the plurality of wagers placed on the second side of the betting line.

13. The system of claim 9, wherein the scoring module computes the outcome based, at least in part, on competitive events between real-world teams during a time span selected from the group consisting of: two previous weeks, three previous weeks, and four previous weeks.

14. The method of claim 9, additionally comprising:
a team build module for selecting players of the first fantasy team based, at least in part, on the one or more real-world performance metrics received by the receiver module.

15. The method of claim 9, additionally comprising:
a user interface for receiving inputs from a user that correspond to selections of players of the first fantasy team.

16. The method of claim 9, wherein
the scoring module computes an expected outcome of the fantasy scoring event using at least two different scoring structures.

17. An interface for a fantasy sports wagering system, comprising:
an input module for receiving performance indications for a plurality of players, the performance indications corresponding to real-world performance metrics of the plurality of players;
a certifying module, coupled to the input module, for certifying that the plurality of players is available for a fantasy scoring event; and
an output module for awarding compensation based, at least in part, on an outcome of the fantasy scoring event and an output of the certifying module.

18. The interface of claim 17, wherein
the output module refrains from awarding compensation the certifying module indicates cancellation of one or more wagers on the outcome of the fantasy scoring event or if the output module does not receive one or more information states indicating certification that the plurality of players is available for a fantasy scoring event.

19. The interface of claim 17, wherein the output module awards non-monetary compensation.

20. The interface of claim 19, wherein the non-monetary compensation corresponds to credit for use at a casino.
